(19) United States
(12) Patent Application Publication
(10) Pub. No.: US 2024/0386610 A1
(43) Pub. Date: Nov. 21, 2024

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Tomohiko TAKEI, Kanagawa (JP)

(73) Assignee: FUJIFILM Business Innovation Corp., Tokyo (JP)

(21) Appl. No.: 18/499,249

(22) Filed: Nov. 1, 2023

(30) Foreign Application Priority Data
May 17, 2023 (JP) 2023-081293

(51) Int. Cl. G06T 7/90

(52) U.S. Cl. CPC G06T 7/90; G06T 2207/10024; G06T 2207/30124

(57) ABSTRACT

An image processing system includes: one or plural processors configured to: acquire first color information from an illumination at an observation site; acquire second color information on paper used for printing; switch a calculation method to be used for calculating a target value in a color space of a specific color observed under the illumination, according to the first color information; and calculate the target value in the color space of the specific color, based on the switched calculation method and the second color information.

### CROSS-REFERENCE TO RELATED APPLICATIONS

This application is based on and claims priority under 35 USC 119 from Japanese Patent Application No. 2023-081293 filed May 17, 2023.

### BACKGROUND

### (i) Technical Field

The present invention relates to an information processing system, a non-transitory computer readable medium storing a program, and an information processing method.

### (ii) Related Art

Color reproducibility is crucial in the printing industry. Therefore, a person in charge performs “color calibration” before printing on a paper matter. For color calibration, an illumination of a color of neutral white called a “standard illumination” is used.

### SUMMARY

With the spread of remote work and the like, there is a demand for a technique for supporting digital color calibration in an environment in which the standard illumination cannot be used. Meanwhile, a color temperature of the illumination used at the observation site varies.

Aspects of non-limiting embodiments of the present disclosure relate to an information processing system, a non-transitory computer readable medium storing a program, and an information processing method that improve reproducibility of a color shade in a case where an image of a printout is observed under an illumination having a color temperature lower than a color temperature of a standard illumination, as compared with a case where the color shade of the image of the printout displayed on a display is reproduced by using a single calculation method.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing system including: one or a plurality of processors, in which the one or plurality of processors are configured to: acquire first color information from an illumination at an observation site; acquire second color information on paper used for printing; switch a calculation method to be used for calculating a target value in a color space of a specific color observed under the illumination, according to the first color information; and calculate the target value in the color space of the specific color, based on the switched calculation method and the second color information.

### BRIEF DESCRIPTION OF THE DRAWINGS

Exemplary embodiment(s) of the present invention will be described in detail based on the following figures, wherein:

FIG. 1 is a diagram illustrating a color temperature;

FIG. 2 is a diagram illustrating an example of a configuration of an information processing system assumed in Exemplary Embodiment 1;

FIG. 3 is a diagram illustrating an example of a hardware configuration of a server;

FIG. 4 is a diagram illustrating an example of a functional configuration of the server;

FIG. 5 is a diagram illustrating two types of calculation methods;

FIG. 6 is a diagram illustrating an example of a coefficient table in which a relationship between a representative color temperature and each coefficient is recorded;

FIG. 7 is a coefficient table corresponding to a case where a color temperature of an illumination is 3700 K;

FIG. 8 is a diagram illustrating an example of a profile setting screen on a display;

FIG. 9 is a flowchart illustrating a processing operation by an illumination color measurement value acquisition unit, a correction formula determination unit, a paper color measurement value acquisition unit, and a target value calculation unit;

FIG. 10 is a flowchart illustrating a processing operation by a display color measurement value acquisition unit, a setting value calculation model creation unit, a setting value calculation unit, and a display setting unit; and

FIG. 11 is a diagram illustrating a change of a tone correction curve before and after adjustment of a color of white.

### DETAILED DESCRIPTION

Hereinafter, exemplary embodiments of the present invention will be described with reference to drawings.

### Exemplary Embodiment

### Color Temperature

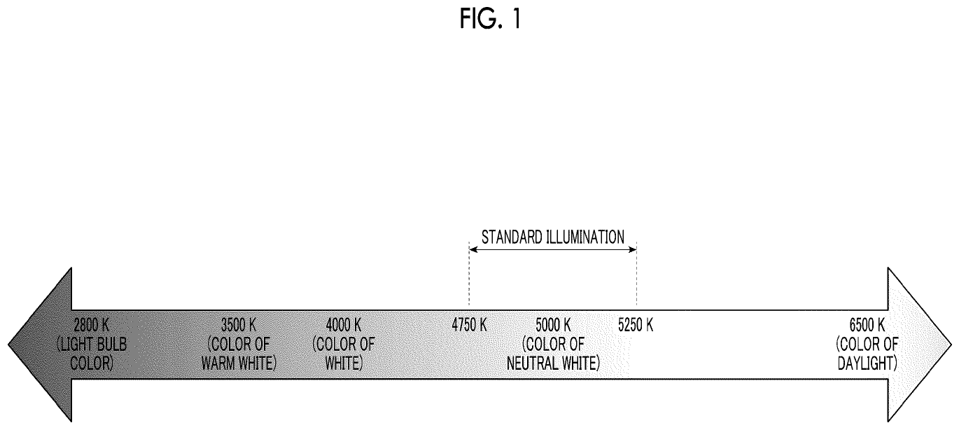

FIG. 1 is a diagram illustrating a color temperature. The higher a numerical value of a color temperature (that is, the right side), the more bluish white a color is, and the lower the numerical value of the color temperature (that is, the left side), the more reddish the color is.

As described above, a standard illumination of around 5000 K is used for color calibration in a printing company or the like. The standard illumination is also called a “color of neutral white”. In FIG. 1, the color of neutral white is approximately in a range of 4750 K to 5250 K. Meanwhile, this classification is an example.

FIG. 1 also illustrates other color classifications. For example, a “color of white” around 4000 K, a “color of warm white” around 3500 K, a “light bulb color” around 2800 K, and a “color of daylight” around 6500 K are illustrated.

The color of white is known as a color of a fluorescent lamp used in a general household or an office. The color of warm white is an intermediate color between the light bulb color and the color of white. The color of daylight is used in a warehouse or a shopping mall.

Hereinafter, a technique capable of performing accurate digital color calibration even under an illumination light having a color temperature other than a color temperature of the standard illumination will be described.

### System Configuration

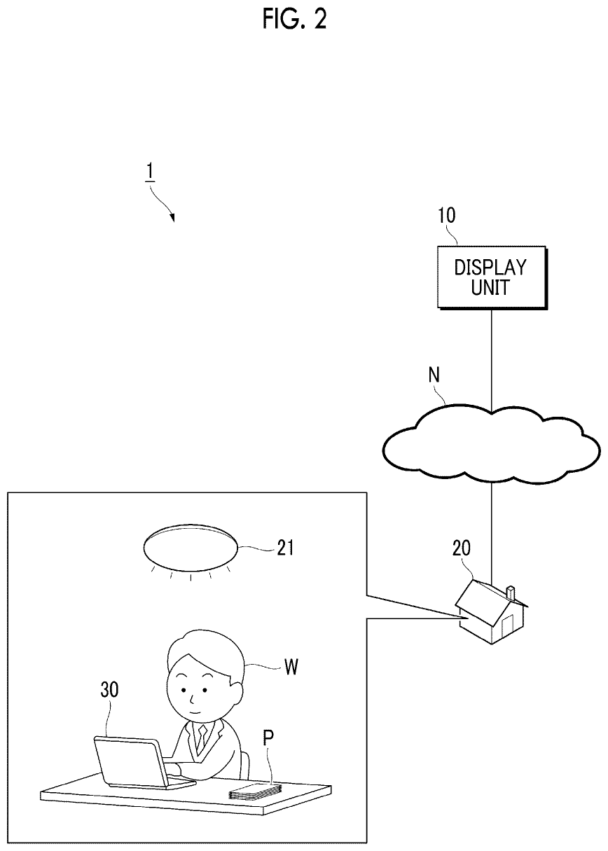

FIG. 2 is a diagram describing an example of a configuration of an information processing system 1 assumed in Exemplary Embodiment 1. The information processing system 1 illustrated in FIG. 2 includes a server 10, a network N, and a house 20 of a remote worker W.

The network N is, for example, the Internet, a wireless local area network (LAN), 4G, 5G, or another mobile communication system.

The server 10 in FIG. 2 is operated by, for example, a printing company in which the remote worker W works. Meanwhile, the server 10 may be operated by a business operator that provides a digital color calibration service.

Although FIG. 2 illustrates the house 20 of the remote worker W, any place can be used as long as the place is used for digital color calibration. For example, a rental booth or a restaurant is also included. These places are examples of observation sites.

In FIG. 2, for convenience of description, a case where there is one remote worker W is illustrated. Meanwhile, in reality, there may be a plurality of remote workers W.

An illumination 21 is installed on a ceiling of the house 20 illustrated in FIG. 2, and a user terminal 30 and paper P used for printing a printout which is a target of digital color calibration are disposed on a desk on which the remote worker W works.

The user terminal 30 is configured with a display and a computer main body, and an image of the printout which is a target of digital color calibration is displayed on the display. In this manner, color calibration using an image displayed on a display is referred to as digital color calibration.

In a case of FIG. 2, the user terminal 30 is used as an input and output device for the server 10. That is, an operation on the user terminal 30 by the remote worker W is transmitted from the user terminal 30 to the server 10 via the network N, and a processing result in the server 10 is transmitted to the user terminal 30 via the network N.

The user terminal 30 may be, for example, any of a desktop computer, a notebook computer, a tablet computer, and a smartphone.

### Hardware Configuration of Server

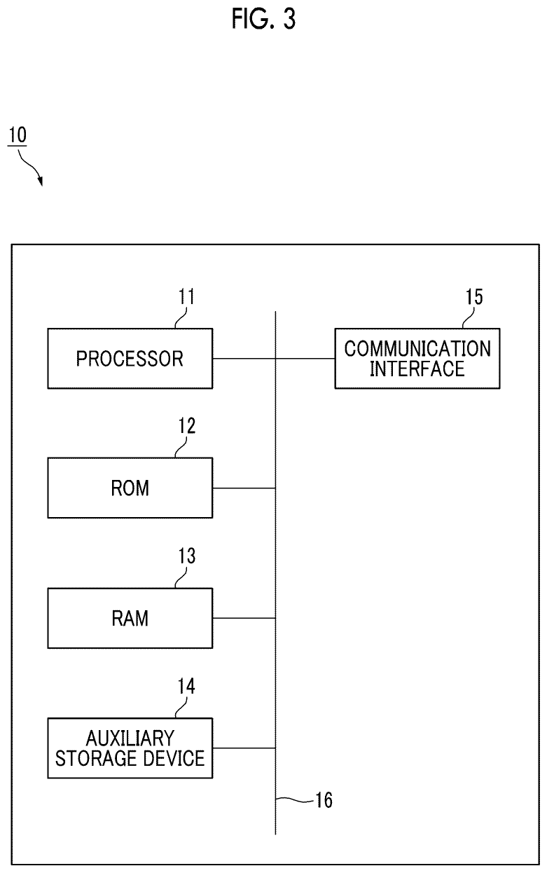

FIG. 3 is a diagram illustrating an example of a hardware configuration of the server 10.

The server 10 illustrated in FIG. 3 includes a processor 11, a read only memory (ROM) 12 in which a basic input output system (BIOS) and the like are stored, a random access memory (RAM) 13 used as a work area of the processor 11, an auxiliary storage device 14, and a communication interface 15. Each device is connected via a bus or another signal line 16.

The processor 11 is a device that realizes various functions through execution of a program.

The processor 11, the ROM 12, and the RAM 13 function as a computer.

The auxiliary storage device 14 is configured with, for example, a hard disk device or a semiconductor storage. A program and various types of data are stored in the auxiliary storage device 14. The program is used as a general term for an operating system (OS) or an application program. One of the application programs is a program that supports digital color calibration by the remote worker W.

The communication interface 15 is an interface for communicating with the user terminal 30 (see FIG. 2) through the network N. The communication interface 15 corresponds to various communication standards. The communication standards here include, for example, Ethernet (registered trademark), Wi-Fi (registered trademark), and a mobile communication system.

### Hardware Configuration of User Terminal

A hardware configuration of the user terminal 30 is substantially the same as the hardware configuration of the server 10. Meanwhile, a display, a mouse, a keyboard, and the like as user interfaces are added. Incidentally, in a case where the user terminal 30 is a notebook computer, a tablet computer, or a smartphone, a capacitive touch sensor having transparency that does not interfere with visual recognition of an image displayed on the display is attached. A device obtained by combining this type of touch sensor and the display is called a touch panel.

### Functional Configuration of Server

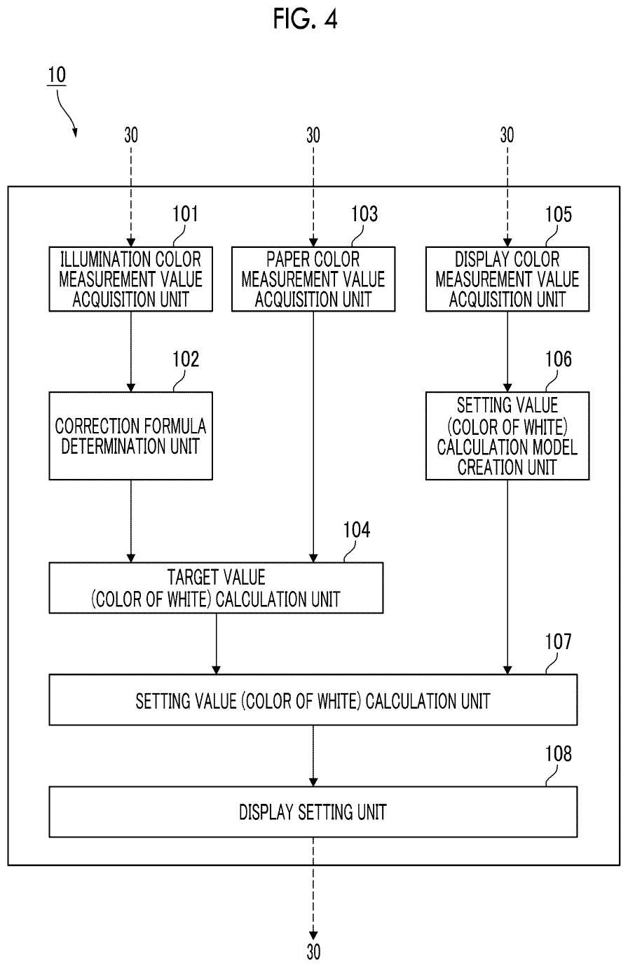

FIG. 4 is a diagram illustrating an example of a functional configuration of the server 10. The functional configuration illustrated in FIG. 4 is realized through execution of a program by the processor 11 (see FIG. 3).

Among functions realized through the execution of the program, functional units illustrated in FIG. 4 correspond to a function for adjusting a display color of a display used for digital color calibration, according to a color temperature of illumination light.

The server 10 illustrated in FIG. 4 is configured with an illumination color measurement value acquisition unit 101, a correction formula determination unit 102, a paper color measurement value acquisition unit 103, a target value calculation unit 104, a display color measurement value acquisition unit 105, a setting value calculation model creation unit 106, a setting value calculation unit 107, and a display setting unit 108.

The server 10 in the present exemplary embodiment determines a target value of a color of white on a color space such that an appearance of the color of white displayed on the display under the illumination 21 coincides with an appearance of the color of white under a standard illumination.

The focus on the appearance of the color of white is based on the knowledge that persons see colors based on black and white as references.

According to this knowledge, in a case where the appearance of white on the display used for digital color calibration is different from the appearance of white under the standard illumination, a color shade of the image observed on the display becomes different from a color shade observed under the standard illumination. That is, reproduction of the color shade of the image observed by the digital color calibration becomes inaccurate.

Therefore, in the present exemplary embodiment, the color of white is used as a specific color for digital color calibration.

The illumination color measurement value acquisition unit 101 is a functional unit that acquires a color of the illumination 21 (see FIG. 2) of the environment in which the remote worker W works. A colorimeter (not illustrated) is used to measure the color of the illumination 21. In a case of the present exemplary embodiment, the remote worker W measures the color of the illumination 21 by using the colorimeter. In a case of FIG. 4, a color measurement value representing the color of the illumination 21 is uploaded to the illumination color measurement value acquisition unit 101 through the user terminal 30. The color measurement value measured from the illumination 21 is an example of first color information.

In the case of the present exemplary embodiment, the color measurement value is given by an x-value and a y-value of an XYZ color system. The x-value is a ratio of an X-value to a sum of the X-value, a Y-value, and a Z-value in the XYZ color system, and the y-value is a ratio of the Y-value to the sum of the X-value, the Y-value, and the Z-value in the XYZ color system.

The correction formula determination unit 102 is a functional unit that determines a correction formula to be used for calculating a target value of a color of white according to the acquired color measurement value. In the case of the present exemplary embodiment, there are two types of correction formula calculation methods.

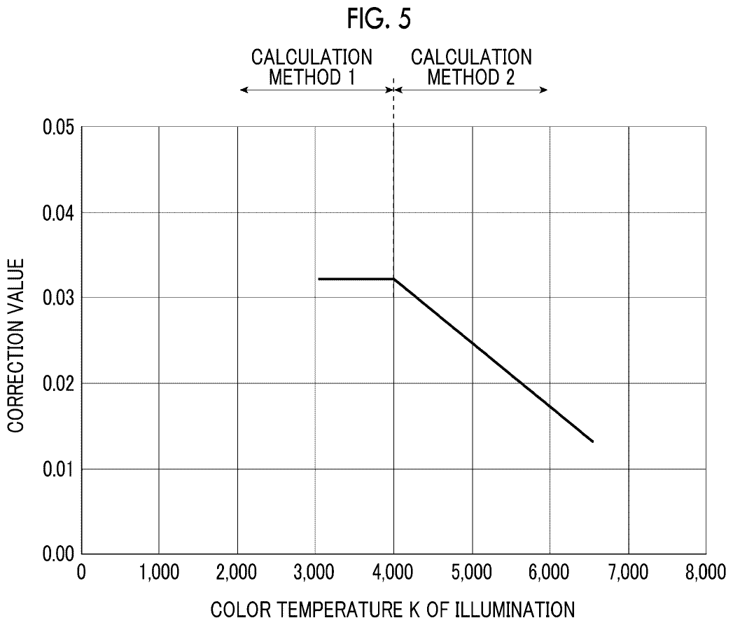

FIG. 5 is a diagram illustrating two types of calculation methods. A horizontal axis represents a color temperature of the illumination 21, and a vertical axis represents a correction value.

The correction value here corresponds to a magnitude of a difference between a color measurement value on a paper surface and a color measurement value on the display, which is necessary to match an appearance of white on the paper surface and an appearance of white on the display.

That is, in a case where the x-value and the y-value in the color space in which the color of white is given on the display are determined to satisfy the correction value illustrated in FIG. 5, the appearance of the color of white displayed on the display under the illumination 21 coincides with the appearance of the color of white on the paper surface under the standard illumination.

That is, the reproducibility of the color shade of the image of the printout displayed on the display is improved. As a result, it is possible to perform accurate digital color calibration under any illumination.

In the case of the present exemplary embodiment, a calculation method 1 is used in a case where a color temperature corresponding to the color measurement value of the illumination 21 is equal to or less than 4000 K, and a calculation method 2 is used in a case where the color temperature corresponding to the color measurement value of the illumination 21 is more than 4000 K.

A difference between the calculation method 1 and the calculation method 2 here depends on a way that the correction value is changed according to a change of the color temperature. The calculation method 1 is an example of a first calculation method, and the calculation method 2 is an example of a second calculation method.

For example, a correction value calculated by a correction formula determined by the calculation method 1 is substantially constant regardless of the color temperature of the illumination 21.

On the other hand, the correction value calculated by the correction formula determined by the calculation method 2 is decreased as the color temperature of the illumination 21 is increased. In FIG. 5, the correction value is decreased linearly to be inversely proportional to the increase in the color temperature, and the correction value may be decreased non-linearly.

Incidentally, both the correction formula determined by the calculation method 1 and the correction formula determined by the calculation method 2 are expressed by the following formulas in which a color measurement value of the paper P is used as a variable.

$$Target value x = a \times color measurement value of paper + b \qquad Formula 1$$

$$Target value y = c \times color measurement value of paper + d \qquad Formula 2$$

Here, the target values x and y are target values of the x-value and the y-value in the color space of the color of white displayed on the display.

The coefficients a and c give a slope of each correction formula, and the coefficients b and d give an intercept of each correction formula.

Incidentally, the coefficients a, b, c, and d of the correction formula to be determined by the calculation method 1 are determined such that the correction value is constant regardless of a difference in color temperature.

On the other hand, the coefficients a, b, c, and d of the correction formula to be determined by the calculation method 2 are determined such that the correction value is linearly decreased as the color temperature is increased.

The values of the coefficients a, b, c, and d corresponding to each color temperature are determined based on a coefficient table prepared for a representative color temperature. In addition, in a case where the coefficients a, b, c, and d corresponding to the color measurement value of the illumination 21 are determined, a correction formula to be used for calculating the target value of the color of white is determined.

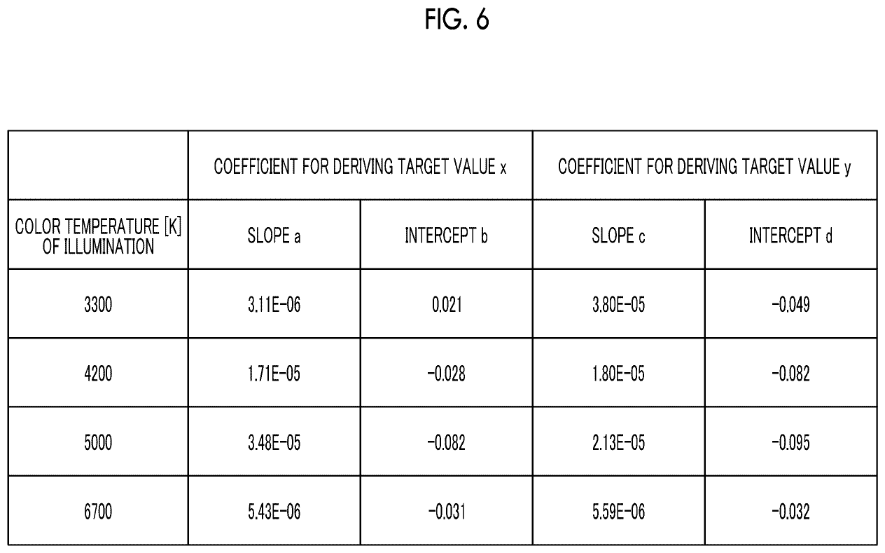

FIG. 6 is a diagram illustrating an example of a coefficient table in which a relationship between a representative color temperature and each coefficient is recorded. The coefficient table illustrated in FIG. 6 is recorded in, for example, the auxiliary storage device 14 (see FIG. 3).

In the coefficient table illustrated in FIG. 6, four representative color temperatures of “3300 K”, “4200 K”, “5000 K”, and “6700 K” are illustrated. Meanwhile, the representative numerical value of the color temperature is an example. The number of color temperatures to be recorded is not limited to four, and may be, for example, three or five, or more.

In the case of the present exemplary embodiment, the coefficients a, b, c, and d corresponding to the representative color temperature are determined, for example, by the following procedure.

First, illuminations having a plurality of types of color temperatures and pieces of paper having one or more types of colors are prepared.

Next, a difference (hereinafter, referred to as “color measurement value difference”) between a color measurement value (that is, x-value and y-value) at a white point on a paper surface and a color measurement value (that is, x-value and y-value) at a point of the color of white on the display in a case where an appearance of the white point on the paper surface and an appearance of the white point on the display coincide with each other at each color temperature is calculated.

The color measurement value difference is calculated as, for example, a sum of squares of a difference Δx between two x-values and a difference Δy between two y-values. Incidentally, the difference Δx here gives a target value x of the correction formula described above, and the difference Δy gives a target value y of the correction formula described above.

By mapping the calculated color measurement value difference on a two-axis graph using the calculated color measurement value difference as a vertical axis and the color temperature as a horizontal axis, a characteristic diagram which is changed to substantially the same shape as in FIG. 5 is obtained. In other words, the polyline diagram illustrated in FIG. 5 corresponds to this characteristic diagram.

For example, the coefficients a, b, c, and d corresponding to “3300 K” are derived such that the differences Δx and Δy between the color measurement value at the white point on the paper surface observed under the standard illumination and the color measurement value at the white point on the display displayed under an illumination of 3300 K satisfy the correction values illustrated in FIG. 5.

Incidentally, in the coefficient table illustrated in FIG. 6, 3.11E-06 is recorded as a slope (that is, the coefficient a) of the correction formula that gives the target value x, and 0.021 is recorded as an intercept (that is, the coefficient b). In the same manner, 3.80E-05 is recorded as a slope (that is, the coefficient c) of the correction formula that gives the target value y, and −0.049 is recorded as an intercept (that is, the coefficient d).

In the coefficient table illustrated in FIG. 6, the corresponding coefficients a, b, c, and d are recorded for “4200 K”, “5000 K”, and “6700 K”.

Meanwhile, the color temperature of the illumination 21 does not always coincide with the four color temperatures prepared in the coefficient table in FIG. 6.

Therefore, the correction formula determination unit 102 determines the coefficients a, b, c, and d for determining a correction formula corresponding to a color temperature of the illumination 21 from the coefficient table illustrated in FIG. 6. For example, the correction formula corresponding to each color temperature is determined by using linear interpolation, polynomial approximation, or the like.

For example, the coefficient a to be used in a case where the color temperature of the illumination 21 is 3700 K can be derived as a linear interpolation of the coefficient a to be used at 3300 K and the coefficient a to be used at 4200 K. The same applies to the coefficients b, c, and d.

Specifically, calculation as the following formulas can be performed.

$$a = 3.11 E - 06 + ( 1.71 E - 05 - 3.11 E - 06 ) * ( 3700 - 3300 ) / ( 4200 - 3200 ) \qquad Formula 3$$

$$b = 0.021 + ( - 0.028 - 0.021 ) * ( 3700 - 3300 ) / ( 4200 - 3200 ) \qquad Formula 4$$

$$c = 3.8 E - 05 + ( 1.8 E - 05 - 3.8 E - 05 ) * ( 3700 - 3300 ) / ( 4200 - 3200 ) \qquad Formula 5$$

$$d = - 0.049 + ( - 0.082 - 0.049 ) * ( 3700 - 3300 ) / ( 4200 - 3200 ) \qquad Formula 6$$

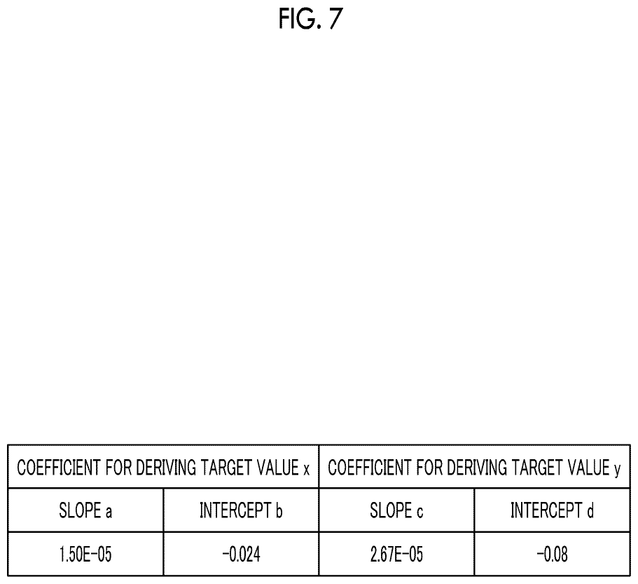

FIG. 7 is a coefficient table corresponding to a case where a color temperature of the illumination 21 is 3700 K.

In a case of FIG. 7, the coefficient a is 1.5E-05, the coefficient b is −0.024, the coefficient c is 2.67E-05, and the coefficient d is −0.08.

In this case, a correction formula is the following formula.

$$Target value x = 1.5 E - 05 \times color measurement value of paper - 0.024 \qquad Formula 7$$

$$Target value y = 2.67 E - 05 \times color measurement value of paper - 0.08 \qquad Formula 8$$

With such a procedure, the correction formula determination unit 102 (see FIG. 4) determines a correction formula according to the color temperature of the illumination 21 at a place at which the remote worker W performs digital color calibration.

The paper color measurement value acquisition unit 103 is a functional unit that measures a color of the paper P of a printout, which is a target of digital color calibration. A colorimeter is also used to measure the color of the paper P. In the case of the present exemplary embodiment, the remote worker W measures the color of the paper P by using the colorimeter. In the case of FIG. 4, a color measurement value representing the color of the paper P is uploaded to the paper color measurement value acquisition unit 103 through the user terminal 30. The color measurement value measured from the paper P is an example of second color information.

The target value calculation unit 104 is a functional unit that calculates a target value by using the correction formula determined according to the color measurement value of the illumination 21 and the color measurement value of the paper P. In a case where the color measurement value of the paper P is not given, a color temperature measured in advance for standard paper such as OS-coated paper is used, for example.

For example, in a case where the color temperature of the illumination 21 is 3700 K and the color temperature of the paper P is 3655 K, the target values x and y are calculated by the following formulas.

$$Target value x = 1.5 E - 05 * 3655 - 0.024 \qquad Formula 9$$

$$Target value y = 2.67 E - 05 * 3655 - 0.08 \qquad Formula 10$$

The display color measurement value acquisition unit 105 is a functional unit that acquires a color of a display used by the remote worker W for digital color calibration. A colorimeter is also used to measure the display color of the display. In the case of the present exemplary embodiment, the remote worker W measures a color of white on the display by using the colorimeter. In the case of FIG. 4, a color measurement value corresponding to a white point on the display is uploaded to the paper color measurement value acquisition unit 103 through the user terminal 30.

The setting value calculation model creation unit 106 is a functional unit that creates a setting value model in which an RGB value for outputting a white point on the display and a color measurement value are associated with each other. The created setting value model is given to the setting value calculation unit 107.

The setting value calculation unit 107 is a functional unit that determines an RGB value for reproducing the x-value and the y-value given as a target value, based on a target value of the color of white calculated by the target value calculation unit 104 and the setting value model given by the setting value calculation model creation unit 106.

The display setting unit 108 is a functional unit that sets an RGB value to be used for outputting the white point on the display, with respect to the user terminal 30 used by the remote worker W.

The user terminal 30 adjusts a tone correction curve of the display, based on, for example, the set RGB value. The adjustment of the color of white also can be performed by, for example, an adjustment by a function of an OS, an adjustment by a display driver, or an adjustment by a color profile of the display.

### User interface Screen

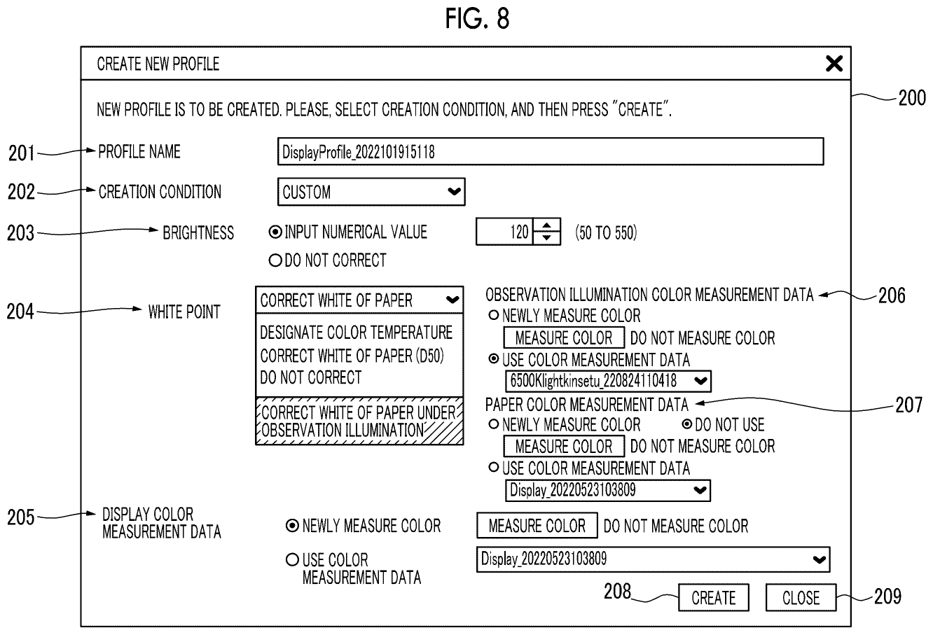

FIG. 8 is a diagram illustrating an example of a profile setting screen 200 of a display.

In the profile setting screen 200 illustrated in FIG. 8, a profile name setting field 201, a creation condition setting field 202, a brightness setting field 203, a white point setting field 204, a display color measurement data setting field 205, an observation illumination color measurement data setting field 206, a paper color measurement data setting field 207, a “create” button 208, and a “close” button 209 are provided.

In a case of FIG. 8, below a “correct white of paper” field in the white point setting field 204, “designate color temperature”, “correct white of paper (D50)”, “do not correct”, and “correct white of paper under observation illumination” are displayed in a pull-down menu.

In FIG. 8, the “correct white of paper under observation illumination” is in a selected state. In a case where the “correct white of paper under observation illumination” is selected, a white point on the display is adjusted according to a color temperature of the illumination 21 (see FIG. 2). D50 refers to the standard illumination.

In the display color measurement data setting field 205, two radio buttons of “measure color newly” and “use color measurement data” are prepared. In FIG. 8, the radio button of “measure color newly” is checked. In a case where the radio button of “use color measurement data” is checked, color measurement data stored in the auxiliary storage device 14 is read.

In the observation illumination color measurement data setting field 206, two radio buttons of “measure color newly” and “use color measurement data” are prepared. A name of a file in which an existing color measurement result is stored is displayed near a radio button corresponding to “use color measurement data”.

In FIG. 8, since the existing color measurement result is used, the radio button of “use color measurement data” is checked.

In the paper color measurement data setting field 207, three radio buttons of “measure color newly”, “use color measurement data”, and “do not use” are prepared. In FIG. 8, the “do not use” radio button is checked.

In a case where the “create” button 208 is operated, a profile set by the remote worker W is created.

On the other hand, in a case where the “close” button 209 is operated, the profile is not created. In a case where there are items set by the remote worker W, all the items are canceled.

### Adjustment Processing at White Point Displayed on Display

Hereinafter, a processing operation executed by the processor 11 (see FIG. 3) in a case where the “correct white of paper under observation illumination” is selected on the profile setting screen 200 (see FIG. 8) of the display will be described.

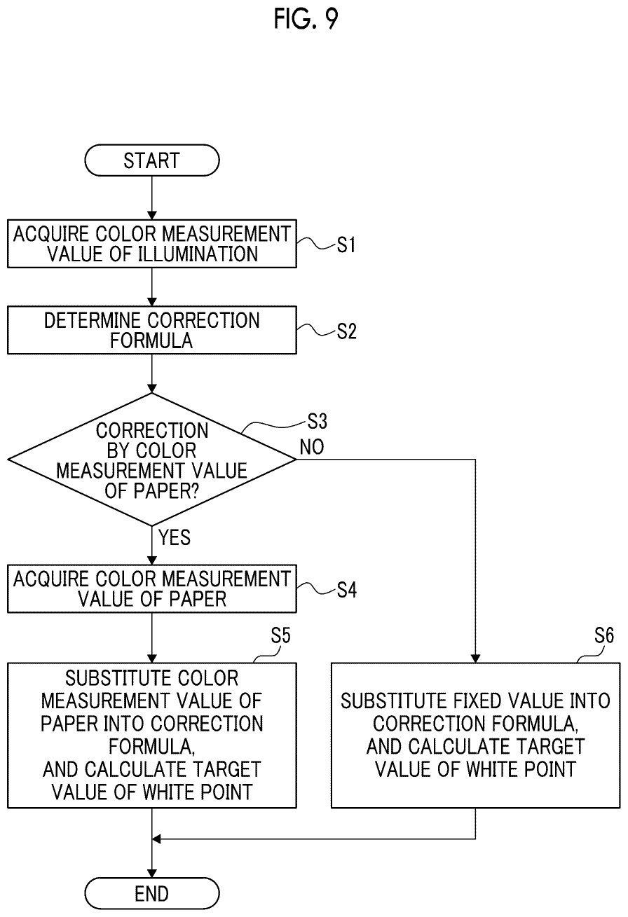

FIG. 9 is a flowchart illustrating a processing operation by the illumination color measurement value acquisition unit 101 (see FIG. 4), the correction formula determination unit 102 (see FIG. 4), the paper color measurement value acquisition unit 103 (see FIG. 4), and the target value calculation unit 104 (see FIG. 4). A symbol S illustrated in FIG. 9 represents a step.

First, the processor 11 acquires a color measurement value of the illumination 21 (see FIG. 2) (step S1). The color measurement value of the illumination 21 is acquired by the illumination color measurement value acquisition unit 101.

In a case where the color measurement value is newly measured by a colorimeter, the illumination color measurement value acquisition unit 101 inputs a color measurement value by the colorimeter from the user terminal 30 (see FIG. 2). On the other hand, in a case where an existing color measurement value is used, the illumination color measurement value acquisition unit 101 reads color measurement data from the auxiliary storage device 14 (see FIG. 3).

Next, the processor 11 determines a correction formula based on the acquired color measurement value (step S2). This determination processing is executed by the correction formula determination unit 102. As described above, the correction formula determination unit 102 determines the correction formula by the calculation method 1 in a case where a color temperature of the illumination 21 is equal to or less than 4000 K, and determines the correction formula by the calculation method 2 in a case where the color temperature of the illumination 21 is more than 4000 K.

Subsequently, the processor 11 determines whether or not to perform a correction based on a color measurement value of paper (step S3). The determination here depends on a setting for the profile setting screen 200 of a display.

In a case where a positive result is obtained in step S3, the processor 11 acquires the color measurement value of the paper (step S4). The paper color measurement value acquisition unit 103 executes acquisition of the color measurement value of the paper.

In a case where the color is newly measured, the paper color measurement value acquisition unit 103 inputs a color measurement value by the colorimeter from the user terminal 30 (see FIG. 2). By acquiring a color measurement value of the paper P actually used for printing, reproducibility of a color shade of an image displayed on the display can be more accurately made closer to an appearance in a case where an image of a printout is observed under the standard illumination.

On the other hand, in a case where an existing color measurement value is used, the paper color measurement value acquisition unit 103 reads color measurement data from the auxiliary storage device 14 (see FIG. 3).

Next, the processor 11 substitutes the color measurement value of the paper into the correction formula, and calculates a target value of a white point (step S5). This processing is executed by the target value calculation unit 104. Specifically, the target value calculation unit 104 calculates the target value x and the target value y, based on Formulas 1 and 2.

On the other hand, in a case where a negative result is obtained in step S3, the processor 11 substitutes a fixed value into the correction formula, and calculates the target value of the white point (step S6).

The fixed value here is a color temperature measured in advance for standard paper such as OS-coated paper, for example, and is registered in advance in the auxiliary storage device 14.

In this manner, the setting of the target value is completed.

Next, the processor 11 executes color adjustment of the display.

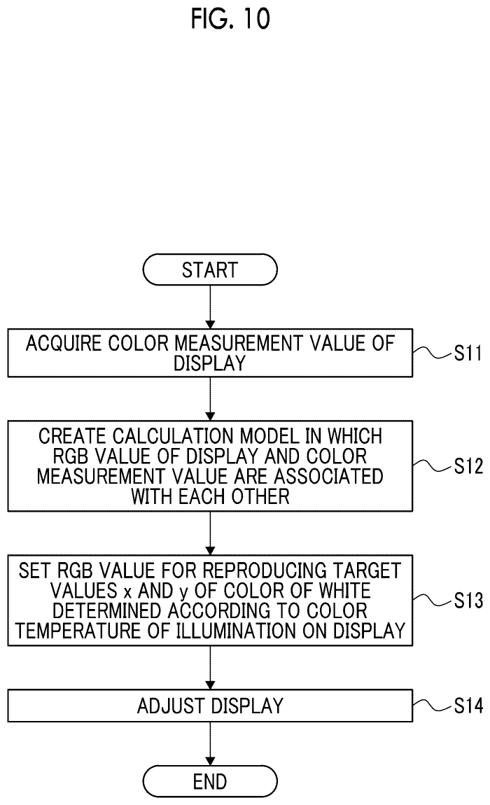

FIG. 10 is a flowchart illustrating a processing operation by the display color measurement value acquisition unit 105 (see FIG. 4), the setting value calculation model creation unit 106 (see FIG. 4), the setting value calculation unit 107 (see FIG. 4), and the display setting unit 108 (see FIG. 4).

First, the processor 11 acquires a color measurement value of the display (step S11). The color measurement value of the display is acquired by the display color measurement value acquisition unit 105.

In a case where the color measurement value is newly acquired by the colorimeter, the display color measurement value acquisition unit 105 inputs the color measurement value by the colorimeter from the user terminal 30 (see FIG. 2).

On the other hand, in a case where an existing color measurement value is used, the display color measurement value acquisition unit 105 reads color measurement data from the auxiliary storage device 14 (see FIG. 3).

Next, the processor 11 creates a calculation model in which an RGB value of the display and the color measurement value are associated with each other (step S12). Specifically, a RGB value of a color at a position at which a color is measured is associated with the color measurement value. This creation processing is executed by the setting value calculation model creation unit 106.

Next, the processor 11 sets the RGB value for reproducing the target values x and y of a color of white determined according to a color temperature of the illumination on the display (step S13). This processing is executed by the setting value calculation unit 107.

Next, the processor 11 adjusts the display (step S14). Specifically, a white balance of the display is adjusted. This processing is executed by the display setting unit 108. As a result, reproducibility of a color shade of an image displayed on the display can be made close to a color shade in a case where an image of a printout is observed under the standard illumination.

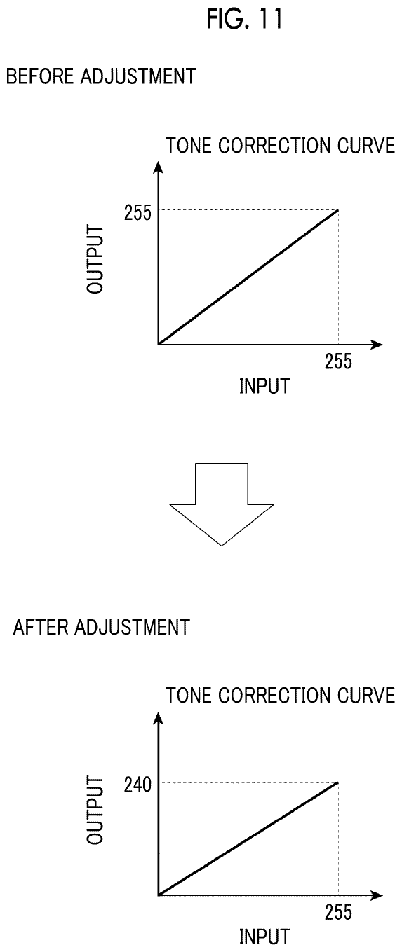

FIG. 11 is a diagram illustrating a change of a tone correction curve before and after adjustment of a color of white. In the tone correction curve before the adjustment, an input of image data of 255 gradations is output as the image data of 255 gradations. On the other hand, in the adjusted tone correction curve, the input of the image data of 255 gradations is output as the image data of 240 gradations.

As a result of this adjustment, even in a case where a color temperature of the illumination 21 is different from the standard illumination, an appearance of a white point on the display is the same as in a case of observation under the standard illumination. As described above, the appearance of white affects the appearance of color by persons. Therefore, by executing the processing operation described above, it is possible to reproduce the same color shade on the display as in the case of observation of an image of a printout under the standard illumination even during the remote work. As a result, it becomes possible to improve accuracy of the digital color calibration.

### Other Exemplary Embodiments

(1) Although the exemplary embodiments of the present invention have been described above, a technical scope of the present invention is not limited to the scope described in the exemplary embodiments described above. It is apparent from claims that exemplary embodiments in which various modifications or improvements are added to the above-mentioned exemplary embodiments are also included in the technical scope of the present invention.

(2) In a case of the exemplary embodiment described above, the color measurement value is given as the x-value and the y-value of the XYZ color system, and may be given by XYZ values of the XYZ color system, may be given by ab values of an Lab color system, or may be given as a value expressed by another color system.

(3) In the exemplary embodiment described above, a color of white is used as an example of a specific color, and red, blue, or another color may be used as the specific color.

(4) In the exemplary embodiment described above, the calculation method 1 is used in a case where the color temperature of the illumination 21 is equal to or less than 4000 K, and the calculation method 2 is used in a case where the color temperature of the illumination 21 is more than 4000 K. Meanwhile, instead of 4000 K, 3500 K may be used, 3750 K may be used, and 4750 K may be used. The calculation method 1 may be used even in a case where the color temperature of the illumination 21 is equal to or more than 5250 K.

(5) In the exemplary embodiment described above, the calculation method 1 is used in a case where the color temperature of the illumination 21 is equal to or less than 4000 K, and the calculation method 2 is used in a case where the color temperature of the illumination 21 is more than 4000 K. Meanwhile, in a case where the color temperature of the illumination 21 is less than a lower limit value of the color temperature of the standard illumination and a case where the color temperature of the illumination 21 is more than an upper limit value of the color temperature of the standard illumination, the calculation method 1 is used, and in a case where the color temperature of the illumination 21 satisfies the color temperature of the standard illumination, the calculation method 2 may be used.

(6) In the exemplary embodiment described above, the calculation method 1 is used in a case where the color temperature of the illumination 21 is equal to or less than 4000 K, and the calculation method 2 is used in a case where the color temperature of the illumination 21 is more than 4000 K. Meanwhile, the calculation method 1 may be used in a case where the color temperature of the illumination 21 is a color of white, a color of warm white, a light bulb color, or a color of daylight, and the calculation method 2 may be used in a case where the color temperature of the illumination 21 is a color of neutral white.

(7) In the exemplary embodiment described above, the description has been made on the premise of digital color calibration in the remote work, the exemplary embodiment can also be used in a case where digital color calibration is performed in a case of performing digital color calibration at an outside location such as the customer's location. In addition, the exemplary embodiment can also be used for digital color calibration at work.

(8) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

(9) In the exemplary embodiment described above, in the server 10 (see FIG. 2), the target values x and y at the white point on the display are calculated according to the color temperature of the illumination 21 (see FIG. 2) provided in the place at which digital color calibration is to be performed, and all the processing of executing color adjustment of the display are executed. Meanwhile, all the corresponding processing may be executed in the user terminal 30 (see FIG. 2). Further, the same processing may be executed in cooperation with the server 10 and the user terminal 30. That is, the processing operation described above may be realized in cooperation with a plurality of processors.

### Supplementary Note

(((1)))

An image processing system comprising:
one or a plurality of processors,
wherein the one or plurality of processors are configured to:
   acquire first color information from an illumination at an observation site;
   acquire second color information on paper used for printing;
   switch a calculation method to be used for calculating a target value in a color space of a specific color observed under the illumination, according to the first color information; and
   calculate the target value in the color space of the specific color, based on the switched calculation method and the second color information.

(((2)))

The image processing system according to (((1))), wherein the one or plurality of processors are configured to:
determine a pixel value to be used for displaying the specific color on a display, according to the target value.

((((3)))

The image processing system according to (((2))), wherein the one or plurality of processors are configured to:
determine the pixel value such that an appearance of the specific color on the display coincides with a color shade determined by the target value.

(((4)))
The image processing system according to any one of (((1))) to (((3))), wherein the one or plurality of processors are configured to:
acquire the first color information by measuring a color of the illumination.

(((5)))

The image processing system according to (((4))), wherein the one or plurality of processors are configured to:
use a value obtained by measuring a color of the paper as the second color information.

(((6)))

The image processing system according to any one of (((1))) to (((5))),
wherein the specific color is white.

(((7)))

The image processing system according to any one of (((1))) to (((6))), wherein the one or plurality of processors are configured to:
in a case where a color temperature corresponding to the first color information is less than a lower limit of a color temperature of a standard illumination, use a first calculation method for calculating the target value, and
in a case where the color temperature corresponding to the first color information is more than the lower limit of the color temperature of the standard illumination, use a second calculation method for calculating the target value.

(((8)))

The image processing system according to any one of (((1))) to (((7))), wherein the one or plurality of processors are configured to:
in a case where a color temperature corresponding to the first color information is a color of white, a color of warm white, a light bulb color, or a color of daylight, use a first calculation method, and
in a case where the color temperature corresponding to the first color information is a color of neutral white, use a second calculation method.

(((9)))

A program causing a computer to realize:
a function of acquiring first color information from an illumination at an observation site;
a function of acquiring second color information on paper used for printing; switching a calculation method to be used for calculating a target value in a color space of a specific color observed under the illumination, according to the first color information; and
a function of calculating the target value in the color space of the specific color, based on the switched calculation method and the second color information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
one or a plurality of processors,
wherein the one or plurality of processors are configured to:
acquire first color information from an illumination at an observation site;
acquire second color information on paper used for printing;
switch a calculation method to be used for calculating a target value in a color space of a specific color observed under the illumination, according to the first color information; and
calculate the target value in the color space of the specific color, based on the switched calculation method and the second color information.

2. The image processing system according to claim 1, wherein the one or plurality of processors are configured to:
determine a pixel value to be used for displaying the specific color on a display, according to the target value.

3. The image processing system according to claim 2, wherein the one or plurality of processors are configured to:
determine the pixel value such that an appearance of the specific color on the display coincides with a color shade determined by the target value.

4. The image processing system according to claim 1, wherein the one or plurality of processors are configured to:
acquire the first color information by measuring a color of the illumination.

5. The image processing system according to claim 4, wherein the one or plurality of processors are configured to:
use a value obtained by measuring a color of the paper as the second color information.

6. The image processing system according to claim 1, wherein the specific color is white.

7. The image processing system according to claim 1, wherein the one or plurality of processors are configured to:
in a case where a color temperature corresponding to the first color information is less than a lower limit of a color temperature of a standard illumination, use a first calculation method, and
in a case where the color temperature corresponding to the first color information is more than the lower limit of the color temperature of the standard illumination, use a second calculation method.

8. The image processing system according to claim 1, wherein the one or plurality of processors are configured to:
in a case where a color temperature corresponding to the first color information is a color of white, a color of warm white, a light bulb color, or a color of daylight, use a first calculation method for calculating the target value, and
in a case where the color temperature corresponding to the first color information is a color of neutral white, use a second calculation method for calculating the target value.

9. A non-transitory computer readable medium storing a program causing a computer to realize:
a function of acquiring first color information from an illumination at an observation site;
a function of acquiring second color information on paper used for printing;
a function of switching a calculation method to be used for calculating a target value in a color space of a specific color observed under the illumination, according to the first color information; and
a function of calculating the target value in the color space of the specific color, based on the switched calculation method and the second color information.

10. An image processing method comprising:
acquiring first color information from an illumination at an observation site;
acquiring second color information on paper used for printing;
switching a calculation method to be used for calculating a target value in a color space of a specific color observed under the illumination, according to the first color information; and
calculating the target value in the color space of the specific color, based on the switched calculation method and the second color information.
